(19) United States
(12) Patent Application Publication
(10) Pub. No.: US 2025/0091150 A1
(43) Pub. Date: Mar. 20, 2025

(54) SOLDER JETTING HEAD CAPABLE OF REDUCING SOLDER PASTE ACCUMULATION, AND RELATED DISPENSING SYSTEMS AND METHODS

(71) Applicant: Kulicke and Soffa Hi-Tech Co., Ltd., New Tapei City (TW)

(72) Inventor: Lu-Min Chen, New Tapei City (TW)

(73) Assignee: Kulicke and Soffa Hi-Tech Co., Ltd., New Tapei City (TW)

(21) Appl. No.: 18/822,662

(22) Filed: Sep. 3, 2024

Related U.S. Application Data
(60) Provisional application No. 63/539,154, filed on Sep. 19, 2023.

(51) Int. Cl. B23K 3/06

(52) U.S. Cl. CPC B23K 3/0638

(57) ABSTRACT

A solder jetting head for depositing a solder paste onto a target surface is provided. The solder jetting head comprising: a tappet portion driven to provide a striking force; and a nozzle portion for forming an enclosing contact with the tappet portion, so as to force the solder paste to exit from a nozzle opening of the nozzle portion, wherein the nozzle portion and the tappet portion are configured to have a sharp-edge contact with each other when forming the enclosing contact.

### CROSS-REFERENCE TO RELATED APPLICATION

This application claims the benefit of U.S. Provisional Application No. 63/539,154, filed Sep. 19, 2023, the content of which is incorporated herein by reference.

### FIELD

The invention relates to a solder jetting head, and in particular, to a solder jetting head capable of reducing solder paste accumulation.

### BACKGROUND

In the processing and packaging of semiconductor devices, jetting is a non-contact printing process which applies solder paste directly to a printed circuit board (PCB) pad. Jetting eliminates the need for a change in Z-axis movement. It significantly increases the speed of placing deposits onto any surface versus contact dispensing. Jetting also makes it easier to deposit solder paste onto surfaces of varying heights. During jetting, small solder paste deposits are placed at a rate of over 1 million dots per hour, to accurately construct the optimum typography for every pad position on the PCB.

However, in a conventional solder jetting head, since a tappet portion is required to strike a nozzle portion with a force great enough for the solder paste deposits to exit through a nozzle opening, when the tappet portion strikes the nozzle portion, solder particles in the solder paste may be compressed between the tappet portion and the nozzle portion so as to deform, accumulate, and eventually interfere with the exiting of the solder paste deposits. Thus, the solder jetting head would have to be replaced or cleaned, and the jetting process would be interfered. Thus, it would increase the time and cost of production.

Referring now to the drawings, FIG. 1 is a cross-sectional view illustrating a conventional solder jetting head. The conventional solder jetting head shown in FIG. 1 includes a tappet portion 10, a nozzle portion 20, and a support portion 30. The tappet portion 10 is driven by a motor (not shown) to provide a striking force (shown by the dark solid arrow). When the tappet portion 10 is driven down toward the nozzle portion 20, the tappet portion 10 would form an enclosing contact with the nozzle portion 20, so as to force a solder paste 50 to exit a nozzle opening 60 in a controlled amount onto a target surface. The support portion 30 is used to support the nozzle portion 20, so that the nozzle portion 20 remains in a stable position after being struck by the tappet portion 10.

However, when the tappet portion 10 is driven downward to contact the nozzle portion 20 to form the enclosing contact, since a shape of the striking end of the tappet portion 10 of a conventional solder jetting head is in a semispherical shape, the contact between the tappet portion 10 and the nozzle portion 20 is essentially a ring shape.

This would cause the tappet portion 10 and the nozzle portion 20 to hit and squeeze solder particles 40 in the solder paste 50. This is shown by the enlarged portion of FIG. 1. Further, since the solder particles 40 in the solder paste 50 are metal particles that are relatively softer than the tappet portion 10 and the nozzle portion 20, this contact would cause the solder particles 40 in the solder paste 50 to be hit and squeezed by the contact surfaces, and thus deform into solder sheets (shown as flat particles in the enlarged portion of FIG. 1). The squeezed solder particles 40 (the solder sheets) may adhere to the contact surfaces. After a while, the solder sheets accumulate and grow larger, and the accumulated solder sheets would eventually prevent the tappet portion 10 and the nozzle portion 20 from forming the enclosing contact. The leaked contact would make the controlled amount deposited onto the target surface unstable. Otherwise, the solder sheets may interfere with the exiting of the solder paste 50 by causing blockage of the nozzle opening 60. Thus, the solder jetting head would have to be replaced or cleaned, and the jetting process would be interfered. Thus, it would increase the time and cost of production.

Thus, the objective of the invention is to provide a solder jetting head capable of reducing solder paste accumulation.

### SUMMARY

To achieve the above objective, a solder jetting head for depositing a solder paste onto a target surface is provided. The solder jetting head according to the invention includes a tappet portion driven to provide a striking force; and a nozzle portion for forming an enclosing contact with the tappet portion, so as to force the solder paste to exit from a nozzle opening of the nozzle portion, wherein the nozzle portion and the tappet portion are configured to have a sharp-edge contact with each other when forming the enclosing contact, so as to provide a minimal contact.

According to another exemplary embodiment of the invention, a dispensing system for depositing a solder paste onto a target surface of a workpiece is provided. The dispensing system includes a support structure for supporting the workpiece during a dispensing operation. The dispensing system also includes a solder jetting head for dispensing the solder paste onto the target surface, the solder jetting head including a tappet portion to provide a striking force and a nozzle portion for forming an enclosing contact with the tappet portion, so as to force the solder paste to exit from a nozzle opening of the nozzle portion, the tappet portion and the nozzle portion configured to have a sharp-edge contact with each other when forming the enclosing contact.

According to other embodiments of the invention, the solder jetting head and/or the dispensing system recited in the immediately two preceding paragraphs may have any one or more of the following features: the nozzle portion and the tappet portion are configured to have a circular line contact with each other when forming the enclosing contact; a shape of the tappet portion is configured so that the circular line contact is created when forming the enclosing contact; a striking end of the tappet portion is configured to have a flat surface; a striking end of the tappet portion is configured to have a semi-spherical shape; a shape of the nozzle portion is configured so that the circular line contact is created when forming the enclosing contact; a striking surface of the nozzle portion is configured to have a cone shape; a striking surface of the nozzle portion is configured to have a flat surface shape, and the nozzle opening has a sharp edge with respect to the flat-surface shaped striking surface of the nozzle portion; a support portion for supporting the nozzle portion; a motion system for moving the solder jetting head with respect to a support structure; and a solder supply for providing solder to the solder jetting head.

According to another exemplary embodiment of the invention, a method of dispensing a solder paste onto a target surface of a workpiece is provided. The method includes the steps of (a) providing the workpiece on a support structure of a dispensing system; and (b) driving a tappet portion of a solder jetting head to strike a nozzle portion of the solder jetting head to force the solder paste to exit from the nozzle portion, the tappet portion and the nozzle portion configured to have a sharp-edge contact with each other during contact, the solder paste exiting the nozzle portion and being dispensed onto the target surface.

According to other embodiments of the invention, the method recited in the immediately preceding paragraph may have any one or more of the following features: a step of providing solder paste to the solder jetting head via a solder supply; a step of moving the solder jetting head into position with a motion system of the dispensing system prior to step (b); step (b) includes striking a striking end of the tappet portion having a flat surface against a striking surface of the nozzle portion having a cone shape to form the sharp-edge contact; step (b) includes striking a striking end of the tappet portion having a semi-spherical shape against a striking portion of the nozzle portion having a flat surface to form the sharp-edge contact.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1 is a cross-sectional view showing a conventional solder jetting head;

FIG. 2 is a cross-sectional view showing a solder jetting head in accordance with a first preferred embodiment of the invention;

FIG. 3 is a cross-sectional view showing a solder jetting head in accordance with a second preferred embodiment of the invention;

FIG. 4 is a block diagram side view of a dispensing system in accordance with an exemplary embodiment of the invention; and

FIG. 5 is a flow diagram illustrating a method of dispensing solder paste onto a target surface in accordance with an exemplary embodiment of the invention.

### DETAILED DESCRIPTION

As used herein, the term “enclosing contact” is intended to refer to the contact made between a tappet portion and a nozzle portion of the solder jetting head. The enclosing contact means that contact is made between the tappet portion and the nozzle portion in a circumferential direction of the tappet portion or the nozzle portion to force the solder paste in an only remaining direction (i.e., an exiting direction through a nozzle opening). Consequently, since an example of the tappet portion is a cylinder with a semispherical end or a cylinder with a flat surface end, it can be understood that the enclosing contact forms as a ring shape or a circular line shape between the tappet portion and the nozzle portion of the solder jetting head.

As used herein, the term “striking force” is intended to refer to the force generated by a motor of a solder jetting head that is used to form the enclosing contact between the tappet portion and the nozzle portion of the solder jetting head. This striking force pushes a controlled amount of solder paste to exit from a nozzle opening of the solder jetting head, so that the controlled amount of solder paste can deposit on any desired surface.

As used herein, the term “solder paste” is intended to refer to any mixture of solder particles (powder) and flux. During jetting, the solder particles could be affected by the enclosing contact between the tappet portion and the nozzle portion of the solder jetting head. That is, the solder particles may be compressed between the tappet portion and the nozzle portion, so as to deform, accumulate, and eventually interfere with the exiting of the solder paste deposits. According to the invention, the compositions or types of the solder paste are not limited. Further, the solder particles shown in the drawings are only intended for the purpose of demonstrating the effect of the forces acted upon the particles or the position of the particles. The solder particles are actually mixed into the solder paste in an evenly distributed manner.

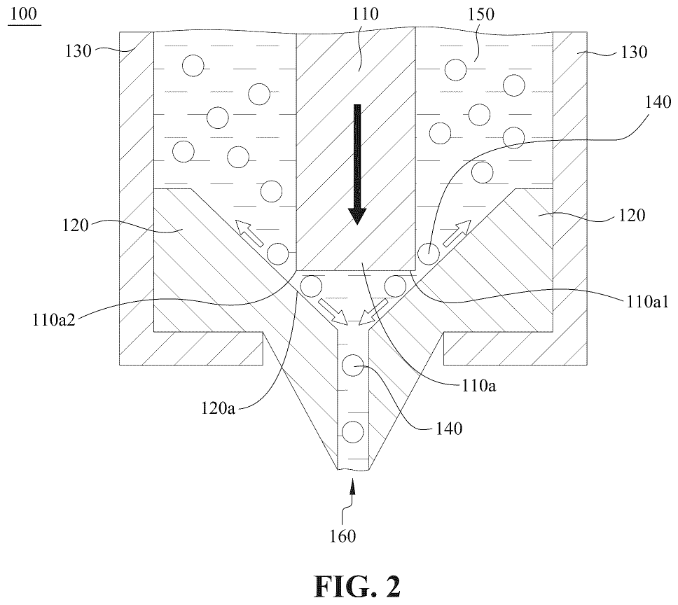

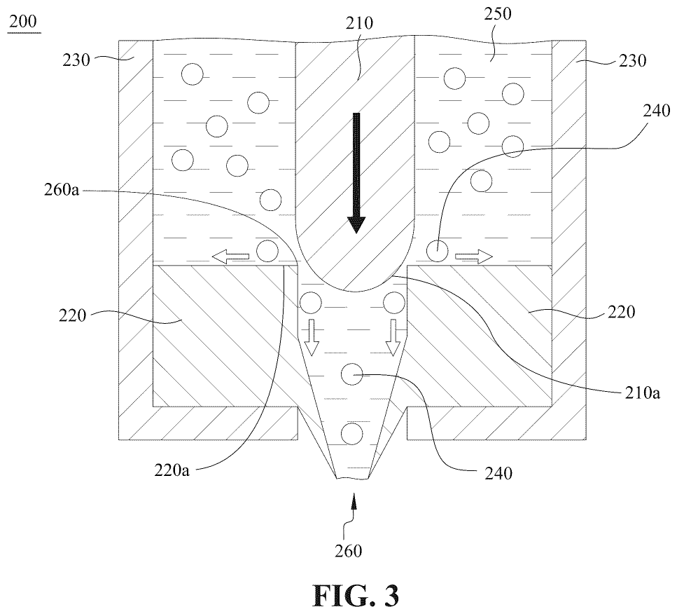

As used herein, the term “sharp-edge contact” is intended to refer to a “pointed” (not flat) contact between the tappet portion and the nozzle portion. For example, in FIG. 2 (cross-sectional view), a tappet portion 110 includes a “pointed” contact with a nozzle portion 120. In another example, in FIG. 3 (cross-sectional view), a nozzle portion 220 includes a “pointed” contact with a tappet portion 210.

Throughout the various drawings provided herein, the same reference numbers refer to the same element. Thus, a description of certain elements may be omitted in connection with some of the drawings.

FIG. 2 is a cross-sectional view showing a solder jetting head 100 in accordance with an embodiment of the invention. The solder jetting head 100 of the invention includes a tappet portion 110, a nozzle portion 120, and a support portion 130. The tappet portion 110 is driven by a motor (not shown) to provide a striking force (shown by the dark solid arrow). When the tappet portion 110 is driven to contact the nozzle portion 120, the tappet portion 110 forms an enclosing contact with the nozzle portion 120, so as to force a solder paste 150 to exit a nozzle opening 160 in a controlled amount onto a target surface. The support portion 130 is used to support the nozzle portion 120, so that the nozzle portion 120 remains in a stable position after being struck by the tappet portion 110.

Further, the nozzle portion 120 and the tappet portion 110 are configured to have minimal contact with each other when forming the enclosing contact. The tappet portion 110 is a cylinder and has a flat surface 110a1. A striking surface 120a of the nozzle portion 120 has a cone shape. That is, a striking end 110a of the tappet portion 110 in accordance with the first embodiment is configured to have flat surface 110a1 instead of a semispherical shape. Thus, a sharp-edge enclosing contact is formed between the tappet portion 110 and the nozzle portion 120. That is, sharp edge 110a2 of tappet 110 contacts striking surface 120a of nozzle portion 120 to form the sharp-edge enclosing contact. When forming the sharp-edge enclosing contact, the nozzle portion 120 and the tappet portion 110 are configured to have minimal contact, i.e., a circular line contact.

That is, since the striking end of the tappet portion 110 is configured to have a flat surface and the nozzle portion 120 and the tappet portion 110 are configured to a circular line contact, when the tappet portion 110 is generating the striking force, it would greatly decrease the surface area of the contact area, i.e., from a strip ring to a circle. That is, since the contact area is decreased significantly, there would be a significantly smaller chance of squeezing the solder particles 140 and causing the solder particles 140 to deform. Furthermore, by creating the circular line contact, the tappet portion 110 and the nozzle portion 120 would also generate a force (which is shown by the hollow arrows) that would cause the solder particles 140 to move out of the vicinity of the circular line contact, as shown in FIG. 2 by the arrows. Thus, it would also significantly decrease the possibility of solder particles 140 being deformed.

Thus, by configuring the nozzle portion 120 and the tappet portion 110 to have minimal contact when forming the sharp-edge enclosing contact, the possibility of solder particles 140 being deformed would significantly decrease. Therefore, it would reduce the squeeze and accumulation of the solder particles 140 in the solder paste 150 as solder sheets, so that the exiting of the solder paste 150 is not interfered. That is, the frequency of replacing or cleaning of the solder jetting head can be reduced. Thus, it is advantageous to the time and cost of production.

FIG. 3 is a cross-sectional view showing a solder jetting head 200 in accordance with an embodiment of the invention. The solder jetting head 200 of the invention includes a tappet portion 210, a nozzle portion 220, and a support portion 230. The tappet portion 210 is driven by a motor (not shown) to provide a striking force (shown by the dark solid arrow). When the tappet portion 210 is driven to contact the nozzle portion 220, the tappet portion 210 forms an enclosing contact with the nozzle portion 220, so as to force a solder paste 250 to exit a nozzle opening 260 in a controlled amount onto a target surface. The support portion 230 is used to support the nozzle portion 220, so that the nozzle portion 220 remains in a stable position after being struck by the tappet portion 210.

That is, the second preferred embodiment is different from the first preferred embodiment in that the tappet portion 210 is different from the tappet portion 110 and the nozzle portion 220 is different from the nozzle portion 120. However, the nozzle portion 220 and the tappet portion 210 are also configured to have minimal contact with each other when forming a sharp-edge enclosing contact. The tappet portion 210 in accordance with the second embodiment is a cylinder with a semispherical striking end 210a. Moreover, the nozzle portion 220 has a flat striking surface 220a, and a cylindrical nozzle opening 260 has a sharp edge 260a with respect to the flat striking surface 220a of the nozzle portion 220. Semispherical striking end 210a of tappet 210 contacts sharp edge 260a to form the sharp-edge enclosing contact. Thus, when forming the sharp-edge enclosing contact, the nozzle portion 220 and the tappet portion 210 are configured to have minimal contact, i.e., a circular line contact.

Thus, due to the above-mentioned reasons, the possibility of solder particles 240 being deformed significantly decreases. Therefore, the second preferred embodiment would prevent the squeeze and accumulation of the solder particles 240 in the solder paste 250 from forming as solder sheets, so that the exiting of the solder paste 250 is not interfered. That is, the frequency of replacing or cleaning of the solder jetting head can be reduced. Thus, it is advantageous to the time and cost of production.

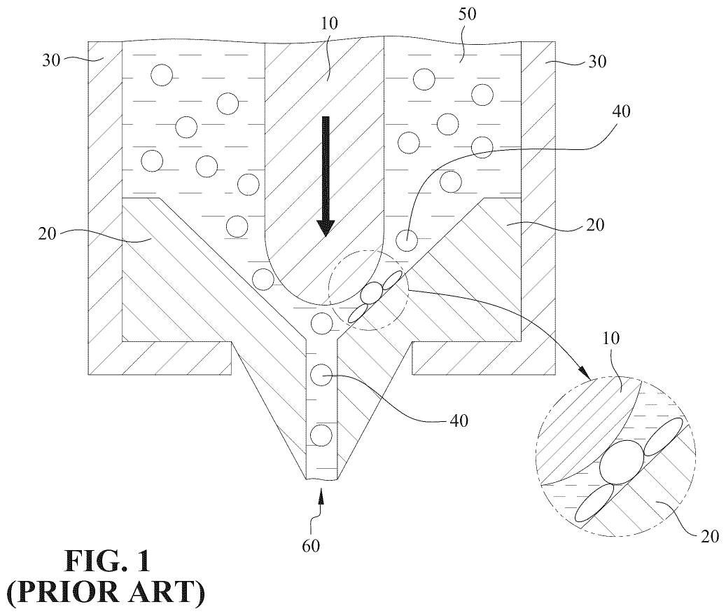

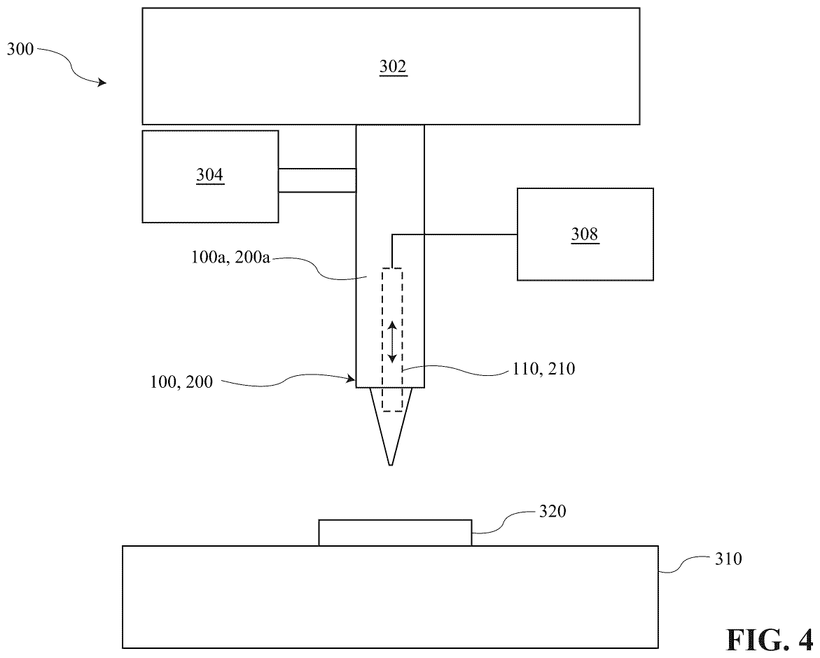

FIGS. 1-3 illustrate only a dispensing end of various solder jetting heads. However, a solder jetting head is conventionally included as an element of a dispensing system. FIG. 4 illustrates such an exemplary dispensing system 300. Dispensing system 300 includes a support structure 310 for supporting a workpiece 320 (e.g., a semiconductor wafer, a printed circuit board, a semiconductor package, a glass substrate, a leadframe, a miniature device (e.g., an LED, a camera, etc.), etc.). Dispensing system 300 also includes a motion system 302 (e.g., a gantry with linear motor(s)) for moving solder jetting head 100, 200 (e.g., along an X, Y, and/or Z axis, about a rotative axis, etc.). Solder jetting head 100, 200 shown in FIG. 4 may represent any solder jetting head within the scope of the invention (e.g., solder jetting head 100 of FIG. 2, solder jetting head 200 of FIG. 3, etc.). Motion system 302 is used to position solder jetting head 100, 200 over workpiece 320. Dispensing system 300 further includes a solder supply 304 for providing solder to a cavity 100a, 200a of solder jetting head 100, 200, respectively. Dispensing system 300 further includes a motor 308 for driving tappet portion 110, 210.

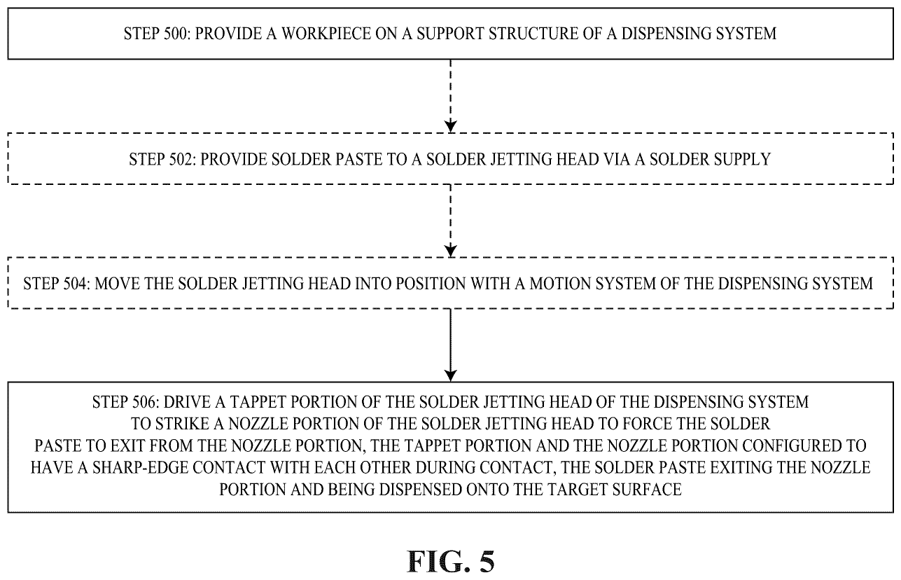

FIG. 5 is a flow diagram illustrating various methods of dispensing a solder paste onto a target surface of a workpiece (e.g., using any of the previously described solder jetting heads and/or dispensing systems). As is understood by those skilled in the art, certain steps included in the flow diagram may be omitted, certain additional steps may be added, and the order of the steps may be altered from the order illustrated-all within the scope of the invention.

At Step 500, a workpiece is provided on a support structure of a dispensing system (e.g., workpiece 320 provided to dispensing system 300). At optional Step 502, a solder paste is provided to the solder jetting head via a solder supply (e.g., solder supply 304). At optional Step 504, the solder jetting head is moved into position using a motion system of the dispensing system (e.g., motion system 302). At Step 506, a tappet portion of a solder jetting head of the dispensing system is driven to strike a nozzle portion of the solder jetting head to force the solder paste to exit from the nozzle portion, the tappet portion and the nozzle portion configured to have a sharp-edge contact with each other during contact, the solder paste exiting the nozzle portion and being dispensed onto the target surface. Step 506 may include striking a striking end of the tappet portion having a flat surface against a striking surface of the nozzle portion having a cone shape to form the sharp-edge contact (e.g., see FIG. 2). Step 506 may include striking a striking end of the tappet portion having a semi-spherical shape against a striking portion of the nozzle portion having a flat surface to form the sharp-edge contact (e.g., see FIG. 3).

In conclusion, aspects of the invention provide a number of potential advantages over a conventional solder jetting head. For example, aspects of the invention include configuring the nozzle portion and the tappet portion to have minimal contact when forming the sharp-edge enclosing contact. Therefore, it would reduce the squeeze and accumulation of the solder particles in the solder paste as solder sheets, so that the exiting of the solder paste is not interfered. That is, the frequency of replacing or cleaning of the solder jetting head can be reduced. Thus, it is advantageous to the time and cost of production.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A solder jetting head for depositing a solder paste onto a target surface, comprising:
a tappet portion driven to provide a striking force; and
a nozzle portion for forming an enclosing contact with the tappet portion, so as to force the solder paste to exit from a nozzle opening of the nozzle portion,
wherein the nozzle portion and the tappet portion are configured to have a sharp-edge contact with each other when forming the enclosing contact.

2. The solder jetting head of claim 1, wherein the nozzle portion and the tappet portion are configured to have a circular line contact with each other when forming the enclosing contact.

3. The solder jetting head of claim 2, wherein a shape of the tappet portion is configured so that the circular line contact is created when forming the enclosing contact.

4. The solder jetting head of claim 3, wherein a striking end of the tappet portion is configured to have a flat surface.

5. The solder jetting head of claim 3, wherein a striking end of the tappet portion is configured to have a semi-spherical shape.

6. The solder jetting head of claim 2, wherein a shape of the nozzle portion is configured so that the circular line contact is created when forming the enclosing contact.

7. The solder jetting head of claim 6, wherein a striking surface of the nozzle portion is configured to have a cone shape.

8. The solder jetting head of claim 6, wherein a striking surface of the nozzle portion is configured to have a flat surface shape, and the nozzle opening has a sharp edge with respect to the flat-surface shaped striking surface of the nozzle portion.

9. The solder jetting head of claim 1 further comprising a support portion for supporting the nozzle portion.

10. A dispensing system for depositing a solder paste onto a target surface of a workpiece, the dispensing system comprising:
a support structure for supporting the workpiece during a dispensing operation; and
a solder jetting head for dispensing the solder paste onto the target surface, the solder jetting head including a tappet portion to provide a striking force and a nozzle portion for forming an enclosing contact with the tappet portion, so as to force the solder paste to exit from a nozzle opening of the nozzle portion, the tappet portion and the nozzle portion configured to have a sharp-edge contact with each other when forming the enclosing contact.

11. The dispensing system of claim 10 further comprising a motion system for moving the solder jetting head with respect to the support structure.

12. The dispensing system of claim 10 further comprising a solder supply for providing solder to the solder jetting head.

13. The dispensing system of claim 10 wherein the nozzle portion and the tappet portion are configured to have a circular line contact with each other when forming the enclosing contact.

14. The dispensing system of claim 13, wherein a shape of the tappet portion is configured so that the circular line contact is created when forming the enclosing contact.

15. The dispensing system of claim 13, wherein a shape of the nozzle portion is configured so that the circular line contact is created when forming the enclosing contact.

16. A method of dispensing a solder paste onto a target surface of a workpiece, the method comprising the steps of:
(a) providing the workpiece on a support structure of a dispensing system; and
(b) driving a tappet portion of a solder jetting head with a motor of the dispensing system to strike a nozzle portion of the solder jetting head to force the solder paste to exit from the nozzle portion, the tappet portion and the nozzle portion configured to have a sharp-edge contact with each other during contact, the solder paste exiting the nozzle portion and being dispensed onto the target surface.

17. The method of claim 16 further comprising the step of providing solder paste to the solder jetting head via a solder supply.

18. The method of claim 16 further comprising the step of moving the solder jetting head into position with a motion system of the dispensing system prior to step (b).

19. The method of claim 16 wherein step (b) includes striking a striking end of the tappet portion having a flat surface against a striking surface of the nozzle portion having a cone shape to form the sharp-edge contact.

20. The method of claim 16 wherein step (b) includes striking a striking end of the tappet portion having a semi-spherical shape against a striking portion of the nozzle portion having a flat surface to form the sharp-edge contact.
